(19) United States
(12) Patent Application Publication
(10) Pub. No.: US 2026/0329965 A1
(43) Pub. Date: Oct. 22, 2026

(54) SCALABLE MATRIX EXTENSION (SME) AWARE QUANTIZATION SYSTEMS AND TECHNIQUES

(71) Applicant: QUALCOMM Incorporated, San Diego, CA (US)

(72) Inventors: Soumya SOMANI, Hyderabad (IN); Goutam MOTIKA, Hyderabad (IN); Cedric BASTOUL, Geispolsheim (FR)

(21) Appl. No.: 19/182,061

(22) Filed: Apr. 17, 2025

(51) Int. Cl. G06F 17/16

(52) U.S. Cl. CPC G06F 17/16

(57) ABSTRACT

Systems and techniques are provided for matrix operations. For instance, a process can include: obtaining a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values; loading the portion of the first row and the portion of the second row into a memory; loading a first sub-tile of quantized values and a second sub-tile of quantized values into the memory; performing a matrix operation using the portion of the first row, the portion of the second row, the first sub-tile of quantized values, and the second sub-tile of quantized values to generate an output matrix; and outputting the output matrix.

### FIELD

Aspects of the present disclosure generally relate to processing instructions. For example, aspects of the present disclosure relate to an instruction for a processor in a scalable matrix extension (SMX) aware quantization format.

### INTRODUCTION

Machine learning (ML) systems (or models), such as neural networks (e.g., deep neural networks) are widely used for numerous applications, such as generative operations (e.g., to generate images, language/text outputs, etc.), object detection, object classification, object tracking, big data analysis, among others. For example, convolutional neural networks (CNNs) are able to extract high-level features, such as facial shapes, from an input image, and use these high-level features to output a probability that, for example, an input image includes a particular object.

Machine learning models may be resource dependent and can use a significant amount of compute, memory, power, and/or time resources for inferencing, and this can limit deployment of certain ML models. To help enable ML model execution, device may include hardware components to help improve ML model performance, such as a neural processing unit and/or matrix unit. These hardware components may help improve ML model performance by handling certain tasks commonly performed by ML models, such as matrix operations.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for secure processing. According to at least one illustrative example, an apparatus for matrix operations is provided. The apparatus includes at least one memory and at least one processor coupled to the at least one memory. The at least one processor is configured to: obtain a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values; load the portion of the first row and the portion of the second row into the at least one memory; load a first sub-tile of quantized values and a second sub-tile of quantized values into the at least one memory; perform a matrix operation using the portion of the first row, the portion of the second row, the first sub-tile of quantized values, and the second sub-tile of quantized values to generate an output matrix; and output the output matrix.

As another example, a method for matrix operations is provided. The method includes: obtaining a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values; loading the portion of the first row and the portion of the second row into a memory; loading a first sub-tile of quantized values and a second sub-tile of quantized values into the memory; performing a matrix operation using the portion of the first row, the portion of the second row, the first sub-tile of quantized values, and the second sub-tile of quantized values to generate an output matrix; and outputting the output matrix.

In another example, a non-transitory computer-readable medium having stored thereon instructions is provided. The instructions, when executed by one or more processors, cause the at one or more processors to: obtain a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values; load the portion of the first row and the portion of the second row into a memory; load a first sub-tile of quantized values and a second sub-tile of quantized values into the memory; perform a matrix operation using the portion of the first row, the portion of the second row, the first sub-tile of quantized values, and the second sub-tile of quantized values to generate an output matrix; and output the output matrix.

As another example, an apparatus for matrix operations is provided. The apparatus includes: means for obtaining a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values; means for loading the portion of the first row and the portion of the second row into a memory; means for loading a first sub-tile of quantized values and a second sub-tile of quantized values into the memory; means for performing a matrix operation using the portion of the first row, the portion of the second row, the first sub-tile of quantized values, and the second sub-tile of quantized values to generate an output matrix; and means for outputting the output matrix.

Aspects generally include a method, apparatus, system, computer program product, non-transitory computer-readable medium, user equipment, base station, wireless communication device, and/or processing system as substantially described herein with reference to and as illustrated by the drawings and specification.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example implementation of a system-on-a-chip (SoC), in accordance with some examples;

FIG. 2A is a block diagram illustrating a processor, in accordance with aspects of the present disclosure;

FIG. 2B is a logical view of an array register, in accordance with aspects of the present disclosure;

FIG. 3 illustrates integer matrix multiplication to generate an outer product, in accordance with aspects of the present disclosure;

FIG. 4 illustrates a LHS matrix with SVL aware quantization into an int-4 format, in accordance with aspects of the present disclosure;

FIG. 5 illustrates a RHS matrix with SVL aware quantization into an int-8 format, in accordance with aspects of the present disclosure;

FIG. 6 illustrates a RHS matrix with SVL aware quantization into an int-8 format with a 32-bit block size, in accordance with aspects of the present disclosure;

FIG. 7 illustrates loading SVL aware quantized matrices for execution, in accordance with aspects of the present disclosure;

FIG. 8 illustrates SVL aware quantization for vector and matrix operations, in accordance with aspects of the present disclosure;

FIG. 9 is a flow diagram illustrating an example of a process for matrix operations, in accordance with aspects of the present disclosure; and

FIG. 10 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Machine learning models can be trained to perform various functions and/or provide various types of outputs. For instance, some generative machine learning models can provide a conversational interface that uses natural language prompts as inputs, such as text or voice. In some examples, a user can provide an input prompt in natural language to the generative machine learning model, and the generative machine learning model can provide a response in natural language form. The input prompt and the output response can optionally be combined with one or more other types of information or data, such as images or files.

While machine learning models (e.g., neural networks) are powerful architectures capable of a wide range of useful tasks, such as recognizing objects in image data, they are likewise highly resource dependent. For example, neural networks may require significant compute, memory, power, and/or time resources for training and/or for inferencing. These resource requirements may significantly limit the ability to train and deploy neural networks to certain types of devices and for certain use cases. For instance, training of machine learning models may be a computationally intensive process that can take a relatively long time, a large quantity of training data, and many operations.

Quantization is a method of mapping continuous values to a smaller set of discrete finite values. For example, quantization approximates real-world values (e.g., floating point values) with representative values (e.g., integer values) that limit the precision and range of the original input. When applied to machine learning, such as to a neural network, quantization may significantly reduce resource usage for both training and inferencing. For example, performing massive numbers of integer operations during training of or inferencing with a quantized (e.g., reduced-precision) neural network may be significantly more efficient in terms of resource usage as compared to performing floating point operations with an unquantized (e.g., full-precision) neural network processing the same input data.

Quantization of trained machine learning models allows quantized trained machine learning models to be efficiently deployed on various devices. Quantization may allow a quantized trained machine learning model to perform operations (e.g., at the inference phase of operation) on a device relatively quickly. Quantization may include changing a format of parameters (e.g., weights and activations) of a machine learning model from the format in which the machine learning model was trained to a different format.

In various aspects of the present disclosure, the term “quantize,” “quantizing,” and like terms may be used as a verb and may be applied to machine learning models, and/or layers of a trained machine learning model. In such cases the term “quantize,” “quantizing,” and like terms may refer to quantizing parameters (e.g., weights and/or activations) as stored in the of the respective machine learning models and/or layers. For example, a trained machine learning model may include weights (e.g., numerical values). During training, and after training, the weights may be stored in the trained machine learning model in a first format (e.g., float16). Quantizing the trained machine learning model may include changing the weights from the first format (e.g., floating point) to a second format (e.g., Int-8).

Further, machine learning models may include activations. Activations can refer to values used as inputs and/or outputs of various functions, operations, and/or layers (or blocks or modules) of the machine learning model. The activations may have a certain format. For example, a function (of a particular layer) may expect to receive values formatted according to the certain format. For instance, the function may read the values from memory according to the certain format. Further, the function may output other values (e.g., based on processing the values read from memory by the function) according to a particular format (which may or may not be the same as the certain format). For instance, the function may write the other values to memory in the particular format. For example, an unquantized trained machine learning model may use FP16 to pass values between functions (e.g., outputting values from one function and reading the values by another function). The activations of the machine learning model can also be quantized. For example, quantizing activations may refer to obtaining values calculated by a layer (e.g., an output of an activation function of the layer) and in the format of discrete values. For instance, the values may be represented with fewer bits, such as 8-bit or 16-bit integer numbers instead of 32-bit floating point numbers. After quantization of the activations the machine learning model is configured to process and/or output, the quantized trained machine learning model may use Int8 or Int16 to pass the values between functions. The term “quantize,” “quantizing,” and like terms may refer to changing how activations are stored and/or used in a quantized machine learning model.

After quantization, various matrix operations may be performed by the ML model. As an example, weights may be quantized into one or more matrices and a dot product may be determined between a matrix and a vector. Similarly, an outer product may be determined for the matrix of weights and another matrix, for example, of activation energies. These matrix operations may be performed using, for example, one or more hardware units, such as a matrix unit. In some cases, these hardware units can be implemented in a variety of ways. For example, the hardware unit may have an array register with a size that can vary as between hardware. In some cases, techniques to efficiently utilize these hardware units for matrix operations may be useful.

Systems, apparatuses, processes (also referred to as methods), and computer-readable media (collectively referred to as “systems and techniques”) are described herein for providing a scalable matrix extension (SME) aware quantization format. For example, a device may obtain a first matrix of quantized values. The matrix of quantized values may be predetermined and stored on the device. In some cases, the matrix of quantized values may be a left-hand side (LHS) matrix. For instance, the first matrix of quantized values may include integer values in a portion of a first row. The values in the first row may be linearized from a first two-dimensional sub-tile of a second matrix of floating-point values. A portion of a second row may be linearized from a second two-dimensional sub-tile of the second matrix of floating-point values. The size/dimension of the tile may be hardware dependent, and a size/dimension of the sub-tiles may be based on the size/dimension of the tile. In some cases, there may be two sub-tiles per tile. The portion of the first row and the portion of the second row may be loaded into a memory such as an array register.

In some cases, the device may determine the matrix of quantized values. For instance, the device may, from a matrix of floating-point values linearize the first two-dimensional sub-tile of the matrix of floating-point values and the second two-dimensional sub-tile of the matrix of floating-point values into a portion of the first row and a portion of the second row. The device may also quantize the floating-point values in the portion of the first row and the portion of the second row. The portions of the first row and the portions of the second row can, along with the full matrix of weights, be loaded into a memory, such as the array register.

A first sub-tile of quantized values and a second sub-tile of quantized values may also be loaded into the memory. The first sub-tile of quantized values and second sub-tile of quantized values may be included in a vector in some cases. The first sub-tile of quantized values and second sub-tile of quantized values may be included in a matrix, such as a right-hand side (RHS) matrix, in other cases. In some cases, the RHS matrix may be linearized and/or packed (e.g., prepared) dynamically at runtime. For example, the RHS matrix may include activations and/or inputs which may vary at runtime. The preparation of the RHS matrix may be performed during inference of the ML model. For example, a RHS matrix of floating-point values may be obtained. The matrix may include a third two-dimensional sub-tile and a fourth two-dimensional sub-tile. The third two-dimensional sub-tile may be linearized to a portion of a first row of another matrix in a column major order. The fourth two-dimensional sub-tile may also be linearized to a portion of a second row of the other matrix in a column major order. The floating-point values in the portion of the first row and portion of the second row may be quantized into integer numbers.

A matrix operation, such as a dot product or outer product, may be performed using the portion of the first row, the portion of the second row, the first sub-tile of quantized values, and the second sub-tile of quantized values to generate an output matrix. This output matrix may be output.

Various aspects of the present disclosure will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The term “mobile device” is used herein to refer to any one or all of cellular telephones, smartphones, Internet-of-things (IOT) devices, personal or mobile multi-media players, laptop computers, tablet computers, ultrabooks, palm-top computers, wireless electronic mail receivers, multimedia Internet enabled cellular telephones, wireless gaming controllers, smart cars, autonomous vehicles, and similar electronic devices which include a programmable processor, a memory and circuitry for sending and/or receiving wireless communication signals to/from wireless communication networks. While the various embodiments are particularly useful in mobile devices, such as smartphones and tablets, the embodiments are generally useful in any electronic device that includes secure boot circuitry for securing access to the electronic device.

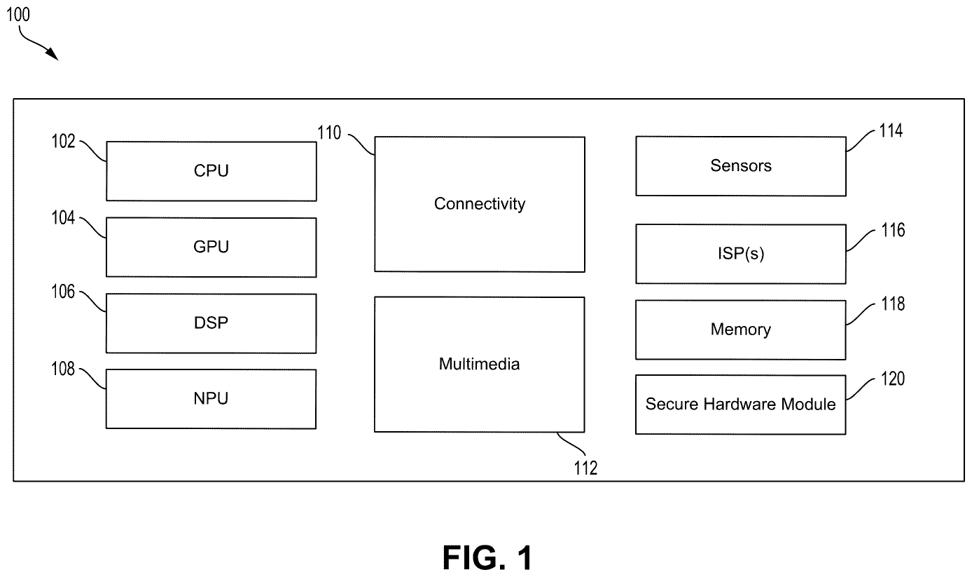

Various aspects of the techniques described herein will be discussed below with respect to the figures. FIG. 1. FIG. 1 illustrates an example implementation of a system-on-a-chip (SoC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

In some cases, the SoC 100 may be based on an ARM instruction set. The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SoC 100 may also include a sensor processor 114, image signal processors (ISPs) 116, and/or a secure hardware module 120.

The secure hardware module 120 may include fuses, replay protected memory block (RPMB), secure bits, secure flags, security enabled hardware, secure memory, or hardware, software, or firmware used to implement a secure portion of the operating system, a secure operating system (SOS), a trusted execution environment (TEE), trusted platform module (TPM), etc. The secure hardware module 120 may be used to process and/or store sensitive data in an environment that is segregated from the rich execution environment in which the operating system and/or applications may be executed. The secure hardware module 120 can be configured to execute trusted applications that provide end-to-end security for sensitive data by enforcing confidentiality, integrity, and protection of the sensitive data stored therein. The secure hardware module 120 can be used to store encryption keys, access tokens, and other sensitive data. In some cases, the secure hardware module 120 may serve as a RoT for the SoC 100. For example, the secure hardware module 120 may provide for the secure generation of cryptographic keys, limitations on the use of such cryptographic keys, and may contain one or more cryptographic keys or elements that may be used to authenticate the SoC 100. In some cases, the RoT may serve to anchor a chain of trust to validate other hardware and/or software. In some cases, the secure hardware module 120 may be implemented as a secure area of the CPU 102, as a part of the SoC 100, or any combination thereof.

The processors of the SoC 100, such as the CPU 102, DSP 106, NPU 108, GPU 104, sensor processor 114, ISP(s) 116, etc., may perform various operations based on instruction sets. An instruction set is a set of commands which tells a processor what operation to perform and what data to perform the operation on. Examples of basic instructions for operations may include read, write, move instructions that may be used to read data from memory, write data to memory, and move data around in memory. Each instruction directs the processor to activate certain parts of the processor (e.g., set of transistors) to use to process the instruction. As an example, certain processors may use a portion of the processor to perform certain operations such as scaler operations, and another portion of the processor to perform other operations, such as vector operations.

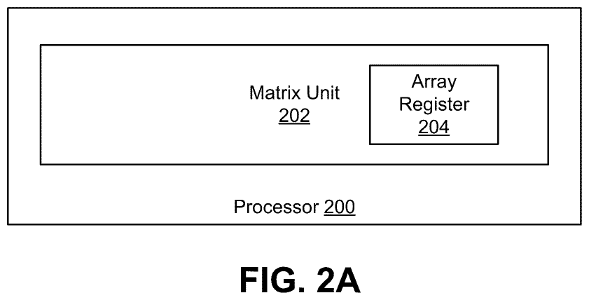

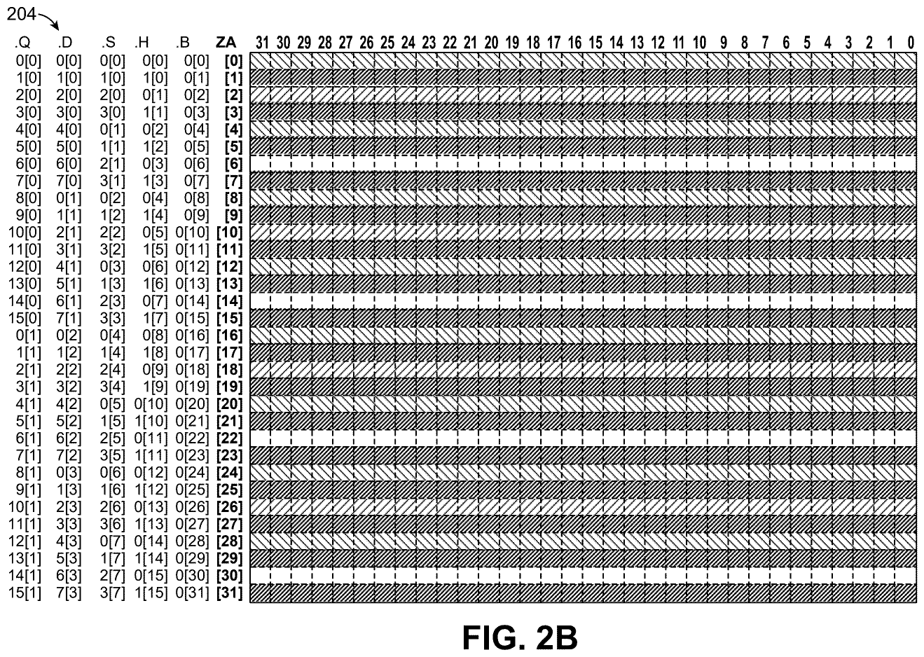

FIG. 2A is a block diagram illustrating a processor 200, in accordance with aspects of the present disclosure. The processor 200 includes a matrix unit 202 for performing matrix operations. The matrix unit 202 may include a memory, such as an array register 204. The array register 204 may be a memory, such as an array of registers. In some cases, the processor includes an instruction set architecture (ISA) that includes instructions, such as scalable matrix extensions (SME), for using the matrix unit 202 to perform the matrix operations. For example, the SME may include algebraic type instructions that causes the matrix unit 202 to receive two vectors as input and calculate an outer product that is accumulated into a 2D tile (e.g., matrix). An outer product of two vectors may be found by multiplying each element of a first vector with an element of a second element to generate a matrix. For example, give two vectors u & v where u=[u₀ u₁ . . . uₘ₋₁]_{1×m} and v=[v₀ v₁ . . . vₙ₋₁]_{1×n}, the outer product O of u & v is a m×n matrix such that:

$$O = {u}^{T} \cdot v = {[ \begin{matrix}{u}_{0} \cdot {v}_{0} & ⋯ & {u}_{0} \cdot {v}_{n - 1} \\ ⋮ & ⋱ & ⋮ \\ {u}_{m - 1} \cdot {v}_{0} & ⋯ & {u}_{m - 1} \cdot {v}_{n - 1}\end{matrix} ]}_{mxn} .$$

Other matrix operations may include loading, storing, inserting and extracting matrix vectors, matrix transpositions, and so forth.

FIG. 2B is a logical view of an array register 204, in accordance with aspects of the present disclosure. In some cases, the array register 204 may be used to store vectors and/or an outer product results from multiplying two vectors. The array register 204 may be thought of as an accumulator for results of matrix operations. In some cases, the array register 204 may be accessed one row (e.g., slice) at a time (as shown) or one column at a time. The array register may be divided into different sized tiles, depending on the input array size, such as 4×4 for 4-bit arrays, 8×8 for 8-bit arrays, 16×16 for 16-bit arrays, etc. A tile may be a sub-matrix of the array register 204.

As an example, a dot product of two 32-bit vectors may fill the array register 204. While the array register 204 is shown as a 32-bit by 32-bit, it should be understood that the array register 204 may be any size (e.g., dimensions). In some cases, the size of the array register 204 may be square such that the array register 204 has a same number of bits/bytes in a column as in a row (e.g., same dimensions). The number of bits/bytes in a row/column of the array register 204 may be referred to as the streaming vector length (SVL).

In cases where the vectors include more elements than a dimension of the array register 204 (e.g., two 64-bit vectors), then two vectors from the left hand side (LHS) and right hand side (RHS) matrices can be loaded and used to compute elements of the output matrix partially. For example, a vector comprising the first row of a first matrix may be multiplied with the first column of a second matrix to find a part of the outer product of the first matrix and the second matrix. This process may be repeated for each row and column of the first and second matrix, respectively.

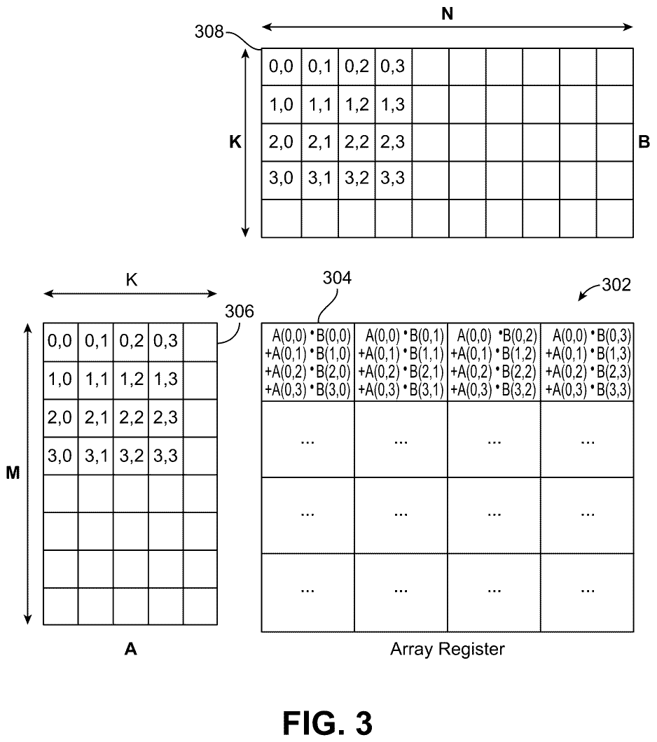

FIG. 3 illustrates integer matrix multiplication to generate an outer product, in accordance with aspects of the present disclosure. In FIG. 3, an array register 302 having an SVL of four is shown for clarity. In some cases, matrix multiplication may be performed on integer values rather than floating point values. Generally, integer values may be smaller in size (e.g., number of bits) as compared to floating point values. For example, a floating point value may be four bytes in size, while a 8-bit signed integer (int-8) may be one byte in size. In some cases, an instruction, such as a signed integer sum of outer products and accumulate (SMOPA) instruction, of the ISA may set up the register so that an element of the register that could hold a floating point result value can hold four int-8 values. A vector of dimensions of SVL×4 may be used such that an element 304 of the array register 302 (e.g., corresponding to array register 204 of FIG. 2A) may hold four consecutive row elements of an int-8 LHS matrix A 306 accumulated with four consecutive column elements of an int-8 RHS matrix B 308 to obtain output with a dimensions of SVLs×SVLs in the element 304 of the array register 302. In some cases the SMOPA instruction may be used as a part of quantization of a machine learning (ML) model for an SME. A quantized ML model may be a ML model, such as a neural network (NN) that was trained to determine floating point values for weights, activation energies, etc., and these floating point values are converted to integer values for inference.

The LHS matrix A 306 has a dimension of M×K and the RHS matrix B 308 has a dimension of N×K. An output matrix from the dot product of the LHS matrix A 306 and RHS matrix B 308 may have a dimension of M×N, and K may be referred to as the depth dimension (e.g., a number of columns in the LHS matrix A 306 and a number of rows in the RHS matrix B 308).

In some cases, it may be useful to quantize ML models in an SVL aware manner (e.g., with an SVL aware quantization). For example, different device may have different sized array registers with different SVLs. A ML model may be quantized to convert floating point values for weights, activation energy, parameters, etc., into integer values for a particular device based on the size of the SVL in the device.

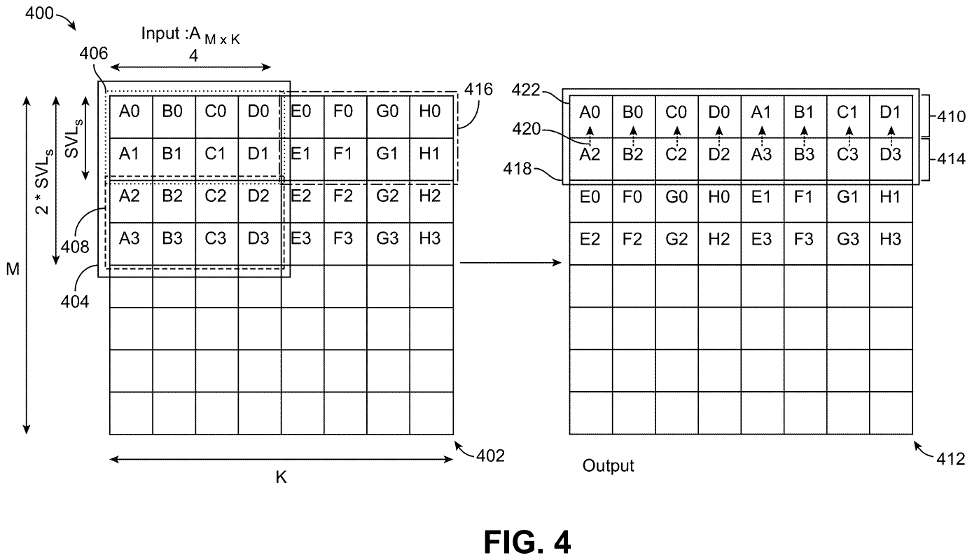

FIG. 4 illustrates a LHS matrix with SVL aware quantization into an int-4 format 400, in accordance with aspects of the present disclosure. The int-4 format may be a 4-bit (e.g., half byte) representation of an integer. In some cases, a matrix, such as input matrix 402 may be prepared for a matrix operation, such as for a SMOPA operation (e.g., matrix operation based on an SMOPA instruction) in an SVL aware manner. For example, the input matrix 402 may be provided along with an instruction to a processor and the processor may generate an output matrix 412. In the example shown in FIG. 4, the input matrix 402 may be a LHS matrix, such as a matrix of ML model weight values. The ML model weight values in the input matrix 402 may be floating point values.

As an example, the input matrix 402 may be quantized for execution on a device with an array register (e.g., array register 302 of FIG. 3) having a tile size 404 of (2*SVLₛ)×4. As an example, given an SVL of 512 bits, or 64 bytes, the number of bytes in the SVL (64) may be divided into 4 to obtain the number of elements in an SVLₛ (e.g., 16 elements, where each element is 4 bytes in size). The tile size/block size may then be (2*SVLₛ)×4=128 elements.

The tile size 404 may be divided into two-dimensional two sub-tiles 406, 408 each with a size of SVLₛ×4 in row-major order. In some cases, the values of the sub-tiles 406, 408 may be linearized in a row major order so that the values of a first sub-tile 406 is organized in a first row 410 of an output matrix 412 and the second sub-tile 408 is organized in a second row 414 of the output matrix 412. Additional sub-tiles may be linearized in a depth dimension, such as for sub-tile 416, and so forth until the values of the input matrix 402 have been linearized into the output matrix 412.

The linearized values in the output matrix 412 may be quantized based on the tile size 404. For example, the linearized values in the output matrix 412 corresponding to the values in the first sub-tile 406 and second sub-tile 408 may be quantized together in a block 418. A block may be a portion of a matrix, such as the output matrix 412, that may be quantized together. For example, the values within one block may be quantized together, thus limiting an effect of outlier values. The size of the block 418 may be equal to the tile size 404. In some cases, the weight values may be quantized in an int-4 format such that the weights are represented as 4-bit integers and a single scale factor (e.g., FP32) may be used for the entire block. The scale factor may represent a ratio of a maximum of a smaller range in a quantized vector to a maximum value in the floating point vector. Each block may have a different scale factor.

As 4-bit integers may be half the size of an int-8 value, as discussed above in FIG. 3, two int-4 values may fit into an int-8 sized element. Thus, the elements of the second row 414 may be packed 420 with the elements of the first row 410 into contiguous bits. For example, a first element 422 of the first row may include the values of A0 and A2. Linearizing in a row major order may place values in a first row, from a right side of the row to the left side of the row, of a matrix (e.g., sub-tile) and place them into a first row of another matrix. After the first row is completed, values from a second row, from a right side of the row to the left side of the row, may also be placed in a first row of the other matrix until the first row is filled and then moving on to the second row, and so forth.

In some cases, the lower bits of an int-8 sized element may include the int-4 elements of the first sub-tile 406 and the upper bits may include the int-4 elements of the second sub-tile 408. Packing the values such that a single int-8 sized element includes two quantized int-4 elements allows an entire tile worth of weights (e.g., (2*SVLₛ)×4) to be loaded using a single load instruction as the array register may be accessed one row at a time. After the array register is loaded, a matrix operation may be performed, such as an SMOPA operation.

Linearizing and packing the input matrix 402 values into the array registers helps avoid having to rearrange data (e.g., with potentially time consuming memory load commands) during runtime as the information for the SMOPA operation may be available in the array register in an order the information may be used. In some cases, as weights are typically fixed for a ML model, the LHS matrix for weights may be linearized before runtime as a part of a preparation process of the ML model for a device and stored on a memory of the device. This preparation process may be performed either by the device or by a second device.

As an example, the device may obtain (e.g., from a memory, such as a non-volatile memory, a matrix (e.g., output matrix 412) of quantized values (e.g., floating point values converted to integer values) where a portion of the first row 410 (e.g., as output matrix 412 is a portion of a full matrix of weights) of the matrix is linearized from a first two-dimensional sub-tile (e.g., sub-tile 406) of an original matrix (e.g., matrix 402) of floating point values (e.g., the weights) and a portion of a second row (e.g., second row 414) linearized from a second two-dimensional sub-tile (e.g., sub-tile 408) of the second matrix of floating point values. The portions of the first row and the portions of the second row can, along with the full matrix of weights, be loaded into a memory, such as the array register.

As another example, the device may, from a matrix of floating point values (e.g., weights) linearize the first two-dimensional sub-tile (e.g., sub-tile 406) of the matrix of floating point values and the second two-dimensional sub-tile (e.g., sub-tile 408) of the matrix of floating point values into a portion of the first row (e.g., first row 410) and a portion of the second row (e.g., second row 414). The device may also quantize the floating-point values in the portion of the first row and the portion of the second row. The portions of the first row and the portions of the second row can, along with the full matrix of weights, be loaded into a memory, such as the array register.

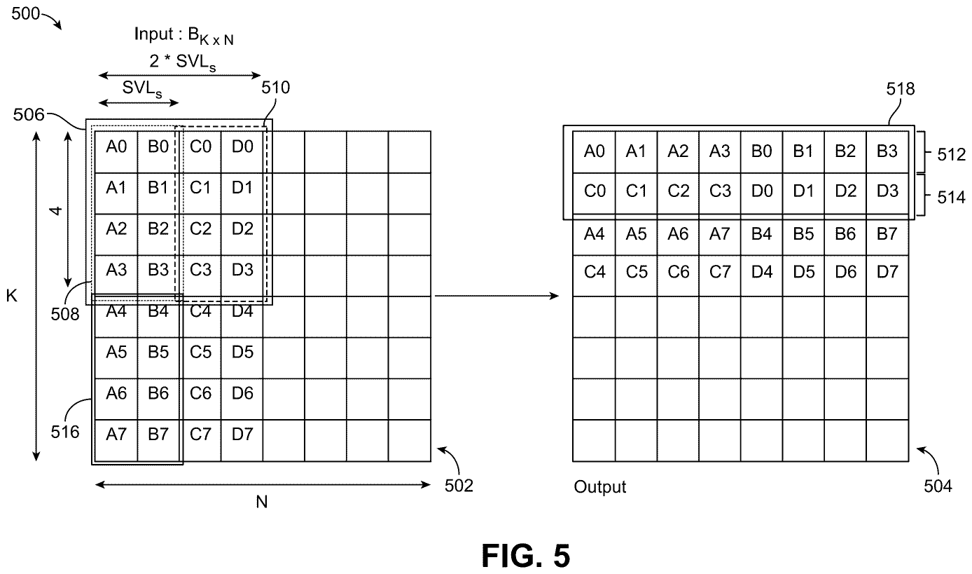

FIG. 5 illustrates a RHS matrix with SVL aware quantization into an int-8 format 500, in accordance with aspects of the present disclosure. In some cases, a matrix, such as input matrix 502 may be prepared for a matrix operation, such as for an SMOPA operation (e.g., matrix operation based on an SMOPA instruction) in an SVL aware manner. For example, the input matrix 502 may be provided along with an instruction to a processor and the processor may generate an output matrix 504. In the example shown in FIG. 5, the input matrix 502 may be a RHS matrix, such as a matrix of ML model activation energies. Values for the ML model activation energies in the input matrix 502 may be floating point values. In FIG. 5, the tile size 506 may be 4×(2*SVLₛ) and the tile size 506 may be divided into two sub-tiles 508, 510.

In some cases, the input matrix 502 may be linearized in a manner similar to linearizing input matrix 402 in FIG. 4. The values of the sub-tiles 508, 510 may be linearized in a column major order so that the values of a first sub-tile 508 is organized in a first row 512 of an output matrix 504 and the second sub-tile 510 is organized in a second row 514 of the output matrix 504. Linearizing in a column major order may place values in a first column, from a top of the column to the bottom of the column, of a matrix (e.g., sub-tile) and place them into a first row of another matrix. After the first column is completed, values from a second column, from a top of the column to the bottom of the column, may also be placed in the first row of the other matrix, until the first row of the matrix is filled, and then filling the next row, and so forth. Additional sub-tiles may be linearized in a depth dimension, such as for sub-tile 516, and so forth until the values of the input matrix 502 have been linearized into the output matrix 504.

The linearized values in the output matrix 504 may be quantized in a manner similar to quantizing linearized values in output matrix 412 in FIG. 4. The linearized values in the output matrix 504 may be quantized based on the tile size 506. For example, the linearized values in the output matrix 504 corresponding to the values in the first sub-tile 508 and second sub-tile 510 may be quantized together in a block 518. In some cases, the activation energy values may be quantized in an int-8 format and a single scale factor (e.g., FP32) may be used for the entire block 518. As the activation energy values may be in an int-8 format, packing may be omitted and the block 518 may be loaded into an array register in two load operations. After the array register is loaded, a matrix operation may be performed, such as an SMOPA operation.

In some cases, the RHS matrix may be linearized and/or packed (e.g., prepared) dynamically at runtime. For example, the RHS matrix may include activations and/or inputs which may vary at runtime. The preparation of the RHS matrix may be performed during inference of the ML model. For example, a RHS matrix (e.g., matrix 502) of floating-point values, such as activations and/or inputs may be obtained. The matrix 502 may include a (e.g., third) two-dimensional sub-tile (e.g., sub-tile 508) and a (e.g., fourth) two-dimensional sub-tile (e.g., sub-tile 510). The (e.g., third) two-dimensional sub-tile may be linearized to a portion of a first row (e.g., row 512) of another matrix in a column major order. The (e.g., fourth) two-dimensional sub-tile may also be linearized to a portion of a second row (e.g., row 514) of the other matrix in a column major order. The floating-point values in the portion of the first row and portion of the second row may be quantized into integer numbers. In some case, a row of quantized values in a tile of the matrix of quantized values may be a sub-tile (e.g., block) of quantized values.

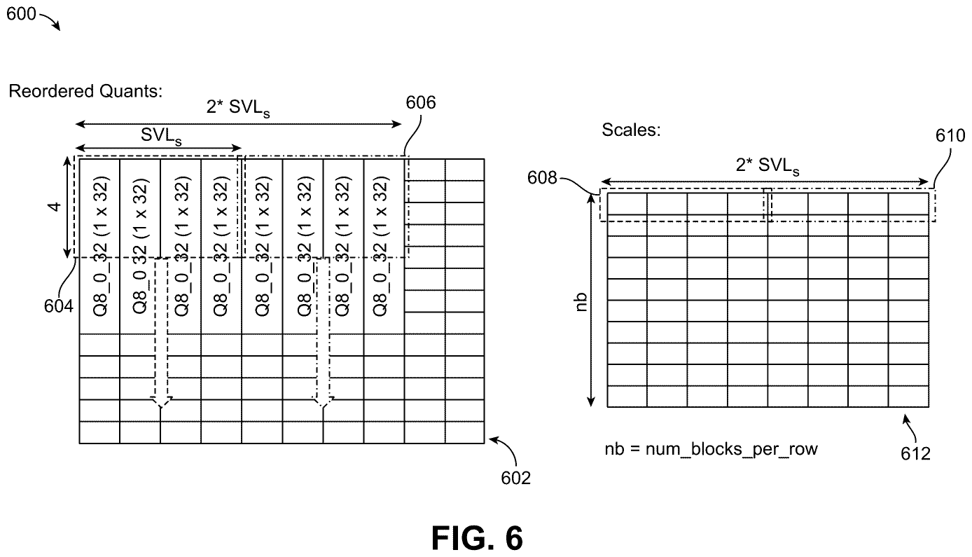

FIG. 6 illustrates a RHS matrix with SVL aware quantization into an int-8 format with a 32-bit block size 600, in accordance with aspects of the present disclosure. In some cases, certain ML models may be sensitive to block sizes of the activation energy values. In such cases, an input matrix including activation energy values may be quantized using a block size of 32 elements per block into an input matrix 602. In some cases, the 32 element per block may be obtained using blocks of n_inner×(2*SVLₛ) for the input matrix. The n_inner×(2*SVLₛ) block as may be linearized and packed in a blockwise manner from 2×(4×SVLₛ) (e.g., two sub-tiles) blocks 604, 606 into two sub-tiles 608, 610 of an output matrix 612 in a manner substantially similar to that discussed with respect to FIG. 5. In some cases, scales may be stored at an end of each n_inner×2SVLₛ block in an array of size (num_blocks_per_row)×(2*SVLₛ) in a blockwise manner. The num_blocks_per_row may be based on n_inner/32.

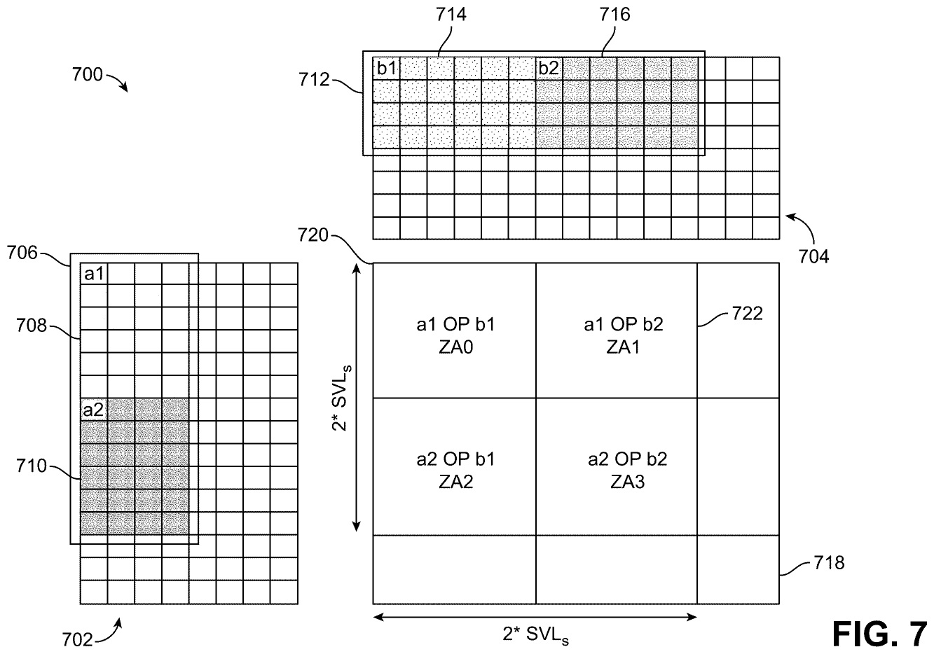

FIG. 7 illustrates loading SVL aware quantized matrices for execution 700, in accordance with aspects of the present disclosure. FIG. 7 includes two matrices, a LHS matrix 702 and a RHS matrix 704. The LHS matrix may be substantially similar to output matrix 412 of FIG. 4 and the RHS matrix may be substantially similar to output matrix 504 of FIG. 5. The LHS matrix 702 includes a tile 706 of dimensions (2*SVLₛ)×4 which has two sub-tiles 708, 710 and tile 706 includes values in an int-4 format. The RHS matrix 704 includes a tile 712 of dimensions 4×(2*SVLₛ) which has two sub-tiles 714, 716 and the tile 712 includes values in an int-8 format. The tile 706 of the LHS matrix 702 may be loaded into an array register 718 from another memory in a single load operation. In some cases, instructions for unpacking the multiple values in a single element may also be included. Each sub-tile 714, 716 of the RHS matrix 704 may be loaded into the array register 718 in single load operation, for a total of three load operations for a matrix operation, such as an outer product instruction. For example, a first sub-tile 708 of the LHS matrix 702 and a first sub-tile 714 of the RHS matrix 704 may be loaded into a first portion 720 of the array register 718. The first sub-tile 708 of the LHS matrix 702 and a second sub-tile 716 of the RHS matrix 704 may be loaded into a second portion 722 of the array register 718, and so forth.

In some cases, four dot product instructions may then be issued, one for each portion of the array register 718 to generate a partially accumulated matrix of 32-bit values for output. The next set of tiles may then be loaded into a depth first manner for processing in a manner substantially similar to the above.

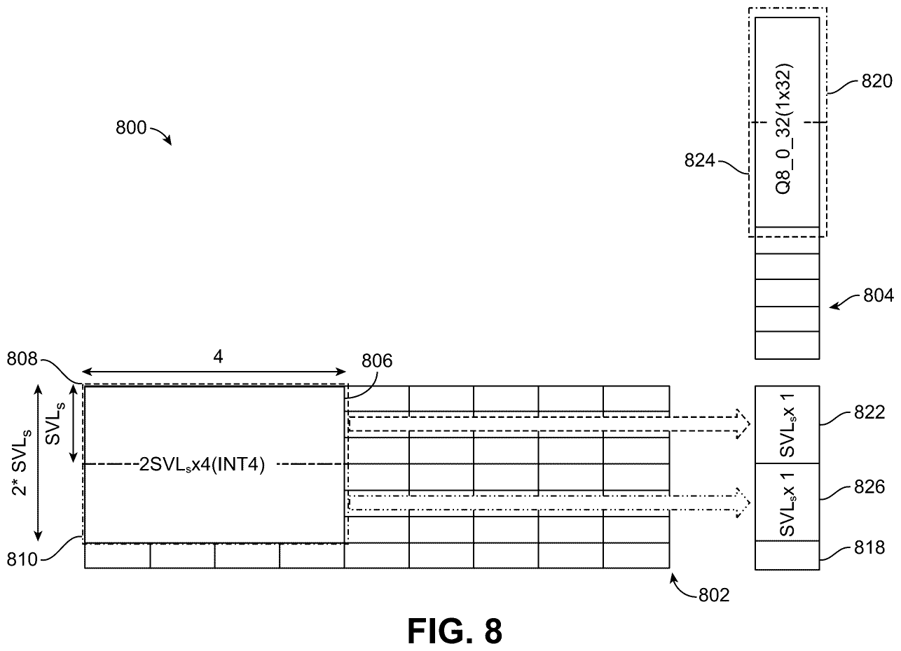

FIG. 8 illustrates SVL aware quantization for vector and matrix operations 800, in accordance with aspects of the present disclosure. In some cases, SVL aware quantization may be extended to support, for example, multiplying a matrix 802 with a vector 804. In some cases, multiplying a matrix 802 with a vector 804 may be used, for example, as a part of token generation (e.g., where a vector represents a token). The matrix 802 that may be similar to output matrix 412 of FIG. 4. The vector 804 may be quantized to an int-8 format using a block size of 32 elements per block. For example, matrix 802 may include a tile 806 with dimensions (2*SVLₛ)×4 which has two sub-tiles 808, 810 and tile 806 includes values in an int-4 format.

A tile 806 of the matrix 802 may be loaded into an array register 818 from another memory in a single load operation, such as via an SVE instruction. Instructions for unpacking the multiple values in a single element may also be included and the tile 806 may be unpacked into two vectors in the matrix register. Unpacking values may extract value(s) from a data structure, such as a matrix or tile, and load the values into a memory in an appropriate configuration or order. A first sub-block 820 (e.g., tile) of 16 int-8 elements (e.g., out of the 32 elements in a block) may be loaded into a first portion 822 of the array register 818, and a second sub-block 824 of 16 int-8 elements may be loaded into a second portion 826 of the array register 818 using two load operations, such as via LD1RQB instructions. A matrix operation may then be performed between the values of the matrix 802 loaded into the memory and the values of the vector 804 loaded into the memory. For example, a dot product of the matrix 802 and the vector 804 may be calculated, for example, using an SDOT instruction to generate a partially accumulated output vector of size 2SVLₛ×1 with int-32 elements (e.g., 32-bit integer elements). Additional sub-tiles of the matrix 802 may then be processed in a depth first manner substantially similar to the above.

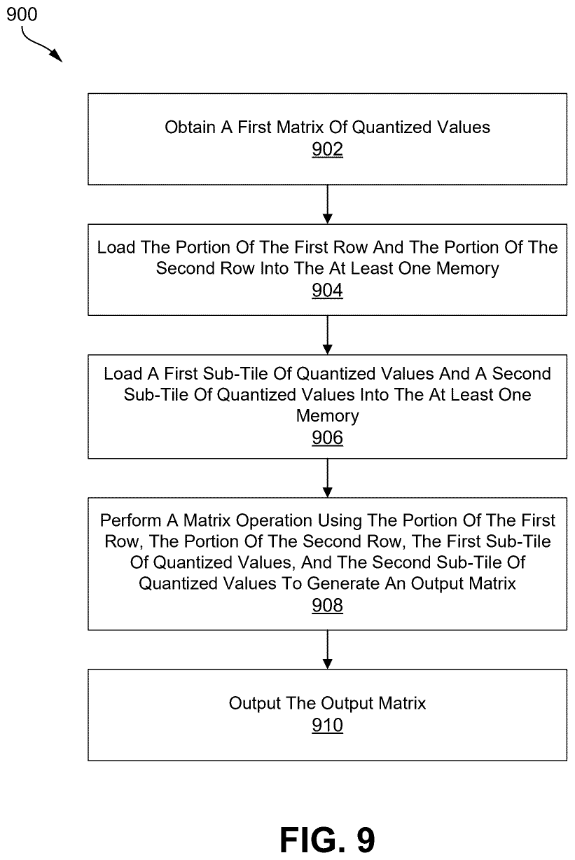

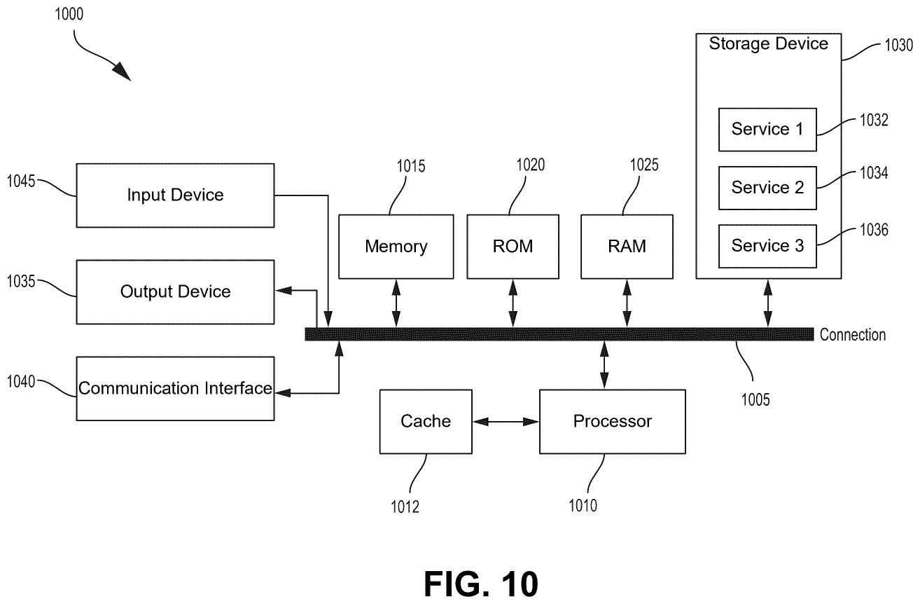

FIG. 9 is a flow diagram illustrating an example of a process 900 for matrix operations, in accordance with aspects of the present disclosure. The process 900 may be performed by a wireless device or by a component (e.g., SoC 100 of FIG. 1, processor 200 of FIG. 2A, matrix unit 202 of FIG. 2A, array register 204 of FIGS. 2A and 2B, array register 302 of FIG. 3, array register 718 of FIG. 7, array register 818 of FIG. 8, processor 1010 of FIG. 10, etc.) or system (e.g., a chipset) of the wireless device (e.g., computing system 1000). The electronic device may be a wireless device, such as computing system 1000, or a UE (e.g., a mobile device such as a mobile phone, a network-connected wearable such as a watch, an extended reality device such as a virtual reality (VR) device or augmented reality (AR) device, a vehicle or component or system of a vehicle, or other type of UE) or other type of network node. In some examples, the process 900 may be performed by a UE. The operations of the process 900 may be implemented, in part, as software components that are executed and run on one or more processors (e.g., CPU 102 of FIG. 1, processor 200 of FIG. 2A, processor 1010 of FIG. 10, or other processor(s)).

At block 902, the computing device (or component thereof) may obtain a first matrix of quantized values (e.g., output matrix 412 of FIG. 4, output matrix 504 of FIG. 5, output matrix 612 of FIG. 6, etc.). In some cases, the first matrix of quantized values includes integer values in a portion of a first row (e.g., first row 410 of FIG. 4, first row 512 of FIG. 5, etc.) linearized from a first two-dimensional sub-tile (e.g., first sub-tile 406 of FIG. 4, first sub-tile 508 of FIG. 5, block 604 of FIG. 6, first sub-tile 708 of FIG. 7, sub-tile 808 of FIG. 8, etc.) of a second matrix of floating-point values (e.g., input matrix 402 of FIG. 4, input matrix 502 of FIG. 5, input matrix 602 of FIG. 6, LHS matrix 702 of FIG. 7, matrix 802 of FIG. 8, etc.) and a portion of a second row (e.g., second row 414 of FIG. 4, second row 514 of FIG. 5, etc.) linearized from a second two-dimensional sub-tile (e.g., second sub-tile 408 of FIG. 4, second sub-tile 510 of FIG. 5, block 606 of FIG. 6, first sub-tile 710 of FIG. 7, sub-tile 810 of FIG. 8, etc.) of the second matrix of floating-point values. In some cases, the first matrix of quantized values includes 4-bit integer values.

At block 904, the computing device (or component thereof) may load the portion of the first row and the portion of the second row into the at least one memory (e.g., array register 204 of FIGS. 2A and 2B, array register 302 of FIG. 3, array register 718 of FUG. 7, array register 818 of FIG. 8, etc.). In some examples, the integer values in the portion of the first row comprises integer values for the portion of the first row and integer values for a portion of a third row, wherein the integer values in the portion of the second row comprises integer values for the portion of the second row and integer values for a portion of a fourth row, and wherein the at least one processor is configured to: unpack the integer values for the portion of the third row into the third row; and unpack the integer values for the portion of the fourth row into the fourth row. In some cases, the computing device (or component thereof) may linearize the first two-dimensional sub-tile of the second matrix of floating-point values and the second two-dimensional sub-tile of the second matrix of floating-point values into the portion of the first row and portion of the second row of the first matrix in a row major order; and quantize floating-point values in the portion of the first row and portion of the second row of the first matrix. In some examples, the first sub-tile of quantized values and a second sub-tile of quantized values are loaded from a third matrix of quantized values.

At block 906, the computing device (or component thereof) may load a first sub-tile of quantized values (e.g., block 418 of FIG. 4, block 518 of FIG. 5) and a second sub-tile of quantized values into the at least one memory. In some cases, a first sub-tile of quantized values (e.g., first sub-block 820 of FIG. 9) and a second sub-tile (e.g., second sub-block 824) of quantized values are loaded from a vector (e.g., vector 804 of FIG. 8) of quantized values.

At block 908, the computing device (or component thereof) may perform a matrix operation using the portion of the first row, the portion of the second row, the first sub-tile of quantized values, and the second sub-tile of quantized values to generate an output matrix.

At block 910, the computing device (or component thereof) may output the output matrix. In some cases, the computing device (or component thereof) may obtain a fourth matrix, the fourth matrix including a third two-dimensional sub-tile of floating-point values and a fourth two-dimensional sub-tile of floating-point values; linearize the third two-dimensional sub-tile of floating-point values to a portion of a first row of the third matrix in a column major order; linearize the fourth two-dimensional sub-tile of floating-point values to a portion of a second row of the third matrix in a column major order; and quantize the floating-point values in the portion of the first row of the third matrix and the floating-point values in the portion of the second row of the third matrix.

In some examples, the processes described herein (e.g., process 900, and/or other process described herein) may be performed by a computing device or apparatus (e.g., a network node such as a UE, base station, a portion of a base station, etc.). For example, as noted above, one or more of the processes described herein (e.g., the process 900, and/or other process described herein) may be performed by a UE.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 900 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, process 900 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some aspects, computing system 1000 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 1000 includes at least one processing unit (CPU or processor) 1010 and connection 1005 that communicatively couples various system components including system memory 1025, such as read-only memory (ROM) 1020 and random access memory (RAM) 1025 to processor 1010. Computing system 1000 may include a cache 1012 of high-speed memory connected directly with, in close proximity to, or integrated as part of processor 1010.

Processor 1010 may include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some aspects, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed by one or more processors, performs one or more of the methods, algorithms, and/or operations described above. The computer-readable data storage medium may form part of a computer program product, which may include packaging materials. The computer-readable medium and/or memory system may comprise any memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, memory 1015, read-only memory (ROM) 1020, random access memory (RAM) 1025, storage device 1030, and the like, and the computer-readable medium may include multiple memories or data storage media. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus, comprising: at least one memory; and at least one processor coupled to the at least one memory, wherein the at least one processor is configured to: obtain a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values; load the portion of the first row and the portion of the second row into the at least one memory; load a first sub-tile of quantized values and a second sub-tile of quantized values into the at least one memory; perform a matrix operation using the portion of the first row, the portion of the second row, the first sub-tile of quantized values, and the second sub-tile of quantized values to generate an output matrix; and output the output matrix.

Aspect 2. The apparatus of Aspect 1, wherein the first matrix of quantized values includes 4-bit integer values.

Aspect 3. The apparatus of Aspect 2, wherein the integer values in the portion of the first row comprises integer values for the portion of the first row and integer values for a portion of a third row, wherein the integer values in the portion of the second row comprises integer values for the portion of the second row and integer values for a portion of a fourth row, and wherein the at least one processor is configured to: unpack the integer values for the portion of the third row into the third row; and unpack the integer values for the portion of the fourth row into the fourth row.

Aspect 4. The apparatus of any of Aspects 1-3, wherein the at least one processor is configured to: linearize the first two-dimensional sub-tile of the second matrix of floating-point values and the second two-dimensional sub-tile of the second matrix of floating-point values into the portion of the first row and portion of the second row of the first matrix in a row major order; and quantize floating-point values in the portion of the first row and portion of the second row of the first matrix.

Aspect 5. The apparatus of any of Aspects 1-4, wherein the first sub-tile of quantized values and a second sub-tile of quantized values are loaded from a vector of quantized values.

Aspect 6. The apparatus of any of Aspects 1-5, wherein the first sub-tile of quantized values and a second sub-tile of quantized values are loaded from a third matrix of quantized values.

Aspect 7. The apparatus of Aspect 6, wherein the at least one processor is configured to: obtain a fourth matrix, the fourth matrix including a third two-dimensional sub-tile of floating-point values and a fourth two-dimensional sub-tile of floating-point values; linearize the third two-dimensional sub-tile of floating-point values to a portion of a first row of the third matrix in a column major order; linearize the fourth two-dimensional sub-tile of floating-point values to a portion of a second row of the third matrix in a column major order; and quantize the floating-point values in the portion of the first row of the third matrix and the floating-point values in the portion of the second row of the third matrix.

Aspect 8. A method for matrix operations, comprising: obtaining a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values; loading the portion of the first row and the portion of the second row into a memory; loading a first sub-tile of quantized values and a second sub-tile of quantized values into the memory; performing a matrix operation using the portion of the first row, the portion of the second row, the first sub-tile of quantized values, and the second sub-tile of quantized values to generate an output matrix; and outputting the output matrix.

Aspect 9. The method of Aspect 8, wherein the first matrix of quantized values includes 4-bit integer values.

Aspect 10. The method of Aspect 9, wherein the integer values in the portion of the first row comprises integer values for the portion of the first row and integer values for a portion of a third row, wherein the integer values in the portion of the second row comprises integer values for the portion of the second row and integer values for a portion of a fourth row, and wherein the method further comprises: unpacking the integer values for the portion of the third row into the third row; and unpacking the integer values for the portion of the fourth row into the fourth row.

Aspect 11. The method of any of Aspects 8-10, further comprising: linearizing the first two-dimensional sub-tile of the second matrix of floating-point values and the second two-dimensional sub-tile of the second matrix of floating-point values into the portion of the first row and portion of the second row of the first matrix in a row major order; and quantizing floating-point values in the portion of the first row and portion of the second row of the first matrix.

Aspect 12. The method of any of Aspects 8-11, wherein the first sub-tile of quantized values and a second sub-tile of quantized values are loaded from a vector of quantized values.

Aspect 13. The method of any of Aspects 8-12, wherein the first sub-tile of quantized values and a second sub-tile of quantized values are loaded from a third matrix of quantized values.

Aspect 14. The method of Aspect 13, further comprising: obtaining a fourth matrix, the fourth matrix including a third two-dimensional sub-tile of floating-point values and a fourth two-dimensional sub-tile of floating-point values; linearizing the third two-dimensional sub-tile of floating-point values to a portion of a first row of the third matrix in a column major order; linearizing the fourth two-dimensional sub-tile of floating-point values to a portion of a second row of the third matrix in a column major order; and quantize the floating-point values in the portion of the first row of the third matrix and the floating-point values in the portion of the second row of the third matrix.

Aspect 15. A non-transitory computer-readable medium having stored thereon instructions that, when executed by one or more processors, cause the one or more processors to: obtain a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values; load the portion of the first row and the portion of the second row into a memory; load a first sub-tile of quantized values and a second sub-tile of quantized values into the memory; perform a matrix operation using the portion of the first row, the portion of the second row, the first sub-tile of quantized values, and the second sub-tile of quantized values to generate an output matrix; and output the output matrix.

Aspect 16. The non-transitory computer-readable medium of Aspect 15, wherein the first matrix of quantized values includes 4-bit integer values.

Aspect 17. The non-transitory computer-readable medium of Aspect 16, wherein the integer values in the portion of the first row comprises integer values for the portion of the first row and integer values for a portion of a third row, wherein the integer values in the portion of the second row comprises integer values for the portion of the second row and integer values for a portion of a fourth row, and wherein the instructions cause the one or more processors to: unpack the integer values for the portion of the third row into the third row; and unpack the integer values for the portion of the fourth row into the fourth row.

Aspect 18. The non-transitory computer-readable medium of any of Aspects 15-17, wherein the instructions cause the one or more processors to: linearize the first two-dimensional sub-tile of the second matrix of floating-point values and the second two-dimensional sub-tile of the second matrix of floating-point values into the portion of the first row and portion of the second row of the first matrix in a row major order; and quantize floating-point values in the portion of the first row and portion of the second row of the first matrix.

Aspect 19. The non-transitory computer-readable medium of any of Aspects 15-18, wherein the first sub-tile of quantized values and a second sub-tile of quantized values are loaded from a vector of quantized values.

Aspect 20. The non-transitory computer-readable medium of any of Aspects 15-19, wherein the first sub-tile of quantized values and a second sub-tile of quantized values are loaded from a third matrix of quantized values.

Aspect 21. An apparatus for matrix operations, comprising one or more means for performing operations according to any of Aspects 8 to 14.

What is claimed is:

1. An apparatus, comprising:
at least one memory; and
at least one processor coupled to the at least one memory, wherein the at least one processor is configured to:
obtain a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values;
load the portion of the first row and the portion of the second row into the at least one memory;
load a first sub-tile of quantized values and a second sub-tile of quantized values into the at least one memory;
perform a matrix operation using the portion of the first row, the portion of the second row, the first sub-tile of quantized values, and the second sub-tile of quantized values to generate an output matrix; and
output the output matrix.

2. The apparatus of claim 1, wherein the first matrix of quantized values includes 4-bit integer values.

3. The apparatus of claim 2, wherein the integer values in the portion of the first row comprises integer values for the portion of the first row and integer values for a portion of a third row, wherein the integer values in the portion of the second row comprises integer values for the portion of the second row and integer values for a portion of a fourth row, and wherein the at least one processor is configured to:
unpack the integer values for the portion of the third row into the third row; and
unpack the integer values for the portion of the fourth row into the fourth row.

4. The apparatus of claim 1, wherein the at least one processor is configured to:
linearize the first two-dimensional sub-tile of the second matrix of floating-point values and the second two-dimensional sub-tile of the second matrix of floating-point values into the portion of the first row and portion of the second row of the first matrix in a row major order; and
quantize floating-point values in the portion of the first row and portion of the second row of the first matrix.

5. The apparatus of claim 1, wherein the first sub-tile of quantized values and a second sub-tile of quantized values are loaded from a vector of quantized values.

6. The apparatus of claim 1, wherein the first sub-tile of quantized values and a second sub-tile of quantized values are loaded from a third matrix of quantized values.

7. The apparatus of claim 6, wherein the at least one processor is configured to:
obtain a fourth matrix, the fourth matrix including a third two-dimensional sub-tile of floating-point values and a fourth two-dimensional sub-tile of floating-point values;
linearize the third two-dimensional sub-tile of floating-point values to a portion of a first row of the third matrix in a column major order;
linearize the fourth two-dimensional sub-tile of floating-point values to a portion of a second row of the third matrix in a column major order; and
quantize the floating-point values in the portion of the first row of the third matrix and the floating-point values in the portion of the second row of the third matrix.

8. A method for matrix operations, comprising:
obtaining a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values;
loading the portion of the first row and the portion of the second row into a memory;
loading a first sub-tile of quantized values and a second sub-tile of quantized values into the memory;
performing a matrix operation using the portion of the first row, the portion of the second row, the first sub-tile of quantized values, and the second sub-tile of quantized values to generate an output matrix; and
outputting the output matrix.

9. The method of claim 8, wherein the first matrix of quantized values includes 4-bit integer values.

10. The method of claim 9, wherein the integer values in the portion of the first row comprises integer values for the portion of the first row and integer values for a portion of a third row, wherein the integer values in the portion of the second row comprises integer values for the portion of the second row and integer values for a portion of a fourth row, and wherein the method further comprises:
unpacking the integer values for the portion of the third row into the third row; and
unpacking the integer values for the portion of the fourth row into the fourth row.

11. The method of claim 8, further comprising:
linearizing the first two-dimensional sub-tile of the second matrix of floating-point values and the second two-dimensional sub-tile of the second matrix of floating-point values into the portion of the first row and portion of the second row of the first matrix in a row major order; and
quantizing floating-point values in the portion of the first row and portion of the second row of the first matrix.

12. The method of claim 8, wherein the first sub-tile of quantized values and a second sub-tile of quantized values are loaded from a vector of quantized values.

13. The method of claim 8, wherein the first sub-tile of quantized values and a second sub-tile of quantized values are loaded from a third matrix of quantized values.

14. The method of claim 13, further comprising:
obtaining a fourth matrix, the fourth matrix including a third two-dimensional sub-tile of floating-point values and a fourth two-dimensional sub-tile of floating-point values;
linearizing the third two-dimensional sub-tile of floating-point values to a portion of a first row of the third matrix in a column major order;
linearizing the fourth two-dimensional sub-tile of floating-point values to a portion of a second row of the third matrix in a column major order; and
quantize the floating-point values in the portion of the first row of the third matrix and the floating-point values in the portion of the second row of the third matrix.

15. A non-transitory computer-readable medium having stored thereon instructions that, when executed by one or more processors, cause the one or more processors to: obtain a first matrix of quantized values, wherein the first matrix of quantized values includes integer values in a portion of a first row linearized from a first two-dimensional sub-tile of a second matrix of floating-point values and a portion of a second row linearized from a second two-dimensional sub-tile of the second matrix of floating-point values;
load the portion of the first row and the portion of the second row into a memory;
load a first sub-tile of quantized values and a second sub-tile of quantized values into the memory;
perform a matrix operation using the portion of the first row, the portion of the second row, the first sub-tile of quantized values, and the second sub-tile of quantized values to generate an output matrix; and
output the output matrix.

16. The non-transitory computer-readable medium of claim 15, wherein the first matrix of quantized values includes 4-bit integer values.

17. The non-transitory computer-readable medium of claim 16, wherein the integer values in the portion of the first row comprises integer values for the portion of the first row and integer values for a portion of a third row, wherein the integer values in the portion of the second row comprises integer values for the portion of the second row and integer values for a portion of a fourth row, and wherein the instructions cause the one or more processors to:
unpack the integer values for the portion of the third row into the third row; and
unpack the integer values for the portion of the fourth row into the fourth row.

18. The non-transitory computer-readable medium of claim 15, wherein the instructions cause the one or more processors to:
linearize the first two-dimensional sub-tile of the second matrix of floating-point values and the second two-dimensional sub-tile of the second matrix of floating-point values into the portion of the first row and portion of the second row of the first matrix in a row major order; and
quantize floating-point values in the portion of the first row and portion of the second row of the first matrix.

19. The non-transitory computer-readable medium of claim 15, wherein the first sub-tile of quantized values and a second sub-tile of quantized values are loaded from a vector of quantized values.

20. The non-transitory computer-readable medium of claim 15, wherein the first sub-tile of quantized values and a second sub-tile of quantized values are loaded from a third matrix of quantized values.
